(19) United States
(12) Patent Application Publication
(10) Pub. No.: US 2009/0249944 A1
(43) Pub. Date: Oct. 8, 2009

(54) METHOD FOR MAKING A MUSICAL CREATION

(76) Inventors: Amotz Ziv Av, Kiryat Ono (IL); Adi Ziv Av, Kiryat Ono (IL)

Correspondence Address: BROWDY AND NEIMARK, P.L.L.C.;624 NINTH STREET, NW, SUITE 300, WASHINGTON, DC, 20001-5303, US

(21) Appl. No.: 12/327,503

(22) Filed: Dec. 3, 2008

(30) Foreign Application Priority Data
Apr. 7, 2008 (IL) 190660

(51) Int. Cl. G10H 7/00

(52) U.S. Cl. 84/609

(57) ABSTRACT

A method is provided for enabling the establishment of a musical creation by integrating a plurality of musical works performed non-simultaneously by a plurality of users, by uploading the plurality of musical works at a pre-define Internet site and integrating that plurality of musical works, thereby establishing the musical creation. In addition, the invention provides that by contributing to the integrated creation the contributor automatically waves his/her respective rights to the musical work, thereby the integrated musical work can freely be played without exposing its player to allegations of infringing any intellectual property rights.

### FIELD OF THE INVENTION

The present invention relates to enabling communications between people and more particularly, to communications between people having similar interests.

### BACKGROUND OF THE INVENTION

One of the major obstacles which almost every new musician faces is how to find the right people to play with. The requirements from a band member are more than just social matching, and originate from the unique activity(ies) which those people participate in. In order for the music being created to sound good, the people who form the group/band need to have chemistry between them in the musical sense, a requirement which might sound rather weird for a non-musician person, but has been experienced by every musician. There are musical compositions that would sound good, while others, irrespective of how good are the musicians themselves, the outcome would be sound as good. Therefore, there are always musicians who are looking for the right people to play with.

Nowadays several solutions are used by the musicians' community to overcome this problem. The most common one is using a bulletin board either being in an electronic form and published in known musician sites or being in a physical form that is published in places associated with musicians (e.g. music stores, music academy etc). Another option for the musicians is to subscribe to an agency that acts somewhat in a way similar to a real estate agency, where the underlying idea of this solution is that the musician pays a certain subscription fee to a company which in exchange finds potential partners for that musician and organizes meetings and recording of the music played.

However, these ideas are not adequate for the musicians, and there is an ever growing strive for new ways to help the musicians' community find partners to play with.

Several attempts were made to encounter the above hurdles. U.S. Pat. No. 6,936,758 discloses a method for providing an objective judgment on a user's performance skill level in playing a musical instrument. The performance skill level of a player is determined by a performance skill level-judging device, and stored in a server. Then, matches can be made according to the user performance skill. This solution may work for some musicians but for most musicians, finding the right partners is more than finding your peers of the same performance skill, but involves finding musical compositions that have good chemistry between the respective members as explained above, a task which cannot be quantified in computerized terms.

U.S. Pat. No. 6,653,545 describes a method and apparatus to allow playing real time music with a number of musicians (jamming) where some of the musician are at remote locations The latency of the communication channel is transferred to the behavior of the local instrument so that a natural accommodation may be made by the musician. This allows musical events that actually occur simultaneously at remote locations to be played together at each location, even though they are not necessarily played simultaneously at all locations. The amount of induced latency may be overridden by each musician, but still is a non trivial thing to achieve, if at all.

### SUMMARY OF THE INVENTION

It is therefore an object of the present invention to provide a method and software to enable musicians to upload their music to a musicians' Internet site and integrate the uploaded pieces of music which were originated from different sources and locations.

It is another object of the present invention to provide a method to enable an Internet site to function as a virtual meeting place for musicians.

It is another object of the present invention to provide a method and software for integrating a joint musical piece performed by more than one user in a computerized environment.

It is still another object of the present invention to provide a business model for providing services to people who wish to join such a musicians' site.

Other objects of the present invention will become more apparent from the following detailed description of the invention taken together with the accompanying examples and appended claims.

Thus, according to a first embodiment of the present invention there is provided a method for enabling the establishment of a musical creation by integrating a plurality of musical works performed non-simultaneously by a plurality of users, wherein the method comprises the following steps:

a) uploading to a pre-define site the plurality of musical works;

b) integrating the plurality of musical works thereby establishing the musical creation.

According to an embodiment of the present invention, each of the plurality of users who are authorized to upload musical works at the pre-defined Internet site is a subscriber of that site, although at least one of this plurality of users, may be a guest at that site. Preferably, subscription fees are charged from a computer user who wishes to initiate an integrated musical creation, or are charged on a fixed basis, or according to any combination thereof (e.g. a relatively modest annual fee and an additional fee every time the user wishes to use the site services for integrating other musical works with his/her own work). Also, the additional fee may inversely depend upon the number of times the user has initiated such a session for integration of musical works. In addition or in the alternative, the other users who upload their musical works are also charged with a pre-determined fee, which could also inversely depend upon the number of times that such a user has already uploaded his/her musical works.

In accordance with another preferred embodiment of the invention, the step of uploading the plurality of musical works comprises the steps of:

(a1) uploading at the pre-define site, a first musical work by a first user;

(a2) enabling at least one other of the plurality of users to listen to at least part of the musical work of the first user; and

(a3) uploading to the pre-define site, at least one other musical work performed by the at least one other user.

As will be appreciated by those skilled in the art, although typically the users will upload their own musical works, still it is not necessary so. Therefore, users of the Internet who enter/subscribe to the site may in fact be users who are not included in the group of the plurality of users who create the musical works, and the present invention should be understood to encompass such an embodiment as well.

According to another embodiment of the invention, the uploading of the at least one other musical work is done irrespective of whether additional related musical works have already been uploaded. In addition or in the alternative, uploading said other musical works is carried out serially, after having a preceding musical work integrated with the latter's preceding musical works.

By yet another preferred embodiment, step (a2) comprises enabling a second user to listen to the at least part of the first user's musical work while that second user is uploading his/her musical work.

In accordance with another embodiment of the invention, the at least one other musical work comprises the first musical work integrated that has already been integrated with the other musical work.

Preferably, the first user is provided with the capability to decide which other users would be allowed to have their musical works integrated with the first musical work, or which other instrument(s) will be used to create the at least one other musical work that will eventually be integrated with the first musical work.

According to yet another embodiment of the invention, the first user may upload his musical work and allow every other user to integrate his/her musical work therewith.

By a preferred embodiment, the first user and every other user who has integrated his/her musical work with that of the first user is informed every time the musical work evolves (i.e. when another musical work is integrated with the integrated combination), thereby enabling unlimited sources of creativity to join in composing a musical creation.

According to another preferred embodiment, by joining this application, the first user as well as every other user who has integrated his/her musical work with that of the first user, automatically wave their respective rights to the musical work, thereby creating an integrated musical work that can freely be played without exposing its player to allegations of infringement of any intellectual property rights such as copyright.

According to yet another embodiment, the step of integrating the plurality of musical works further comprises using sound editing software for merging and/or synchronizing the plurality of musical works into one musical creation.

In accordance with another embodiment of the present invention, the pre-defined site is a musicians' meeting room which preferably comprises at least one member of the group consisting of: editing software, voice chat enabling software, video chat enabling software, text chat enabling software, e-bulletin board oriented for musicians looking for other musicians, electronic advertisements, music database, or any combination thereof. The meeting room may be sub-divided in accordance with specific types of music and/or specific types of instruments to allow easier spotting of a person to participate in the musical creation.

According to yet another embodiment, the users entering the musicians' meeting room are exposed to advertisements inserted by the operators of the Internet site, who in turn charge the entities who wish to advertise their products, services, etc. at that site.

By still another embodiment of the invention, at least the first user (in the alternative—each of the users) is provided with details identifying at least some of the users which participated in the musical creation. For example, their e-mail addresses, instant messaging address and the like, to allow contacting any of these other users for future cooperation. Preferably, the provisioning of such contact details to a user who wishes to receive them requires payment of a pre-defined charge per each such user's record.

According to yet another embodiment of the present invention, prior to enabling a user to upload a musical work and/or to use the sound integrating/editing software, he/she must pre-register as a member of the site. Preferably, there are two types of users in the meeting room. The first type is of registered members who may use all of the features available in the site, whereas the second type is of guests who may use only a limited number of features such as being able to listen to the uploaded musical works (without being able to upload themselves such works).

According to still another embodiment, the method provided further comprising a compatibility step whereby users (preferably registered members) are provided with a questionnaire to enable the site management software to determine their individual musical preferences. The questionnaire could preferably be filled while registering to the site in order to enable the newly joining member to connect with other members as of his/her registration.

According to another embodiment of the present invention, the method further comprises a step of storing data related to a registered member and is preferably used to allow his/her classification. For example, a musical piece uploaded by a certain member may be used to determine the type of the musician he/she is, and his/her performance level. Also, the stored data may comprise statistics about the user's responsiveness to join in creating such musical creations.

By still another embodiment of the invention, the site is provided with means to allow users entering the site (or only those who are subscribers thereof) to rank the various musical works that have been uploaded at the site.

According to yet another embodiment of the present invention becoming a registered member and/or using the sound editing software and/or being able to upload a musical work to obtain such a musical creation, require paying a pre-defined subscription fee.

In accordance with still a further embodiment of the invention, the first user is provided with the capability to invite the other users to join in the formation of the musical creation. Such invitation may be extended by sending electronic messages to certain individual, and/or could include the types of instruments which the first user is interested to join in.

### DESCRIPTION OF THE DRAWINGS

A better understanding of the present invention is obtained when the following non-limiting detailed description is considered in conjunction with the following drawing in which:

FIG. 1 illustrates a flow chart describing the operation of a preferred embodiment according to the present invention.

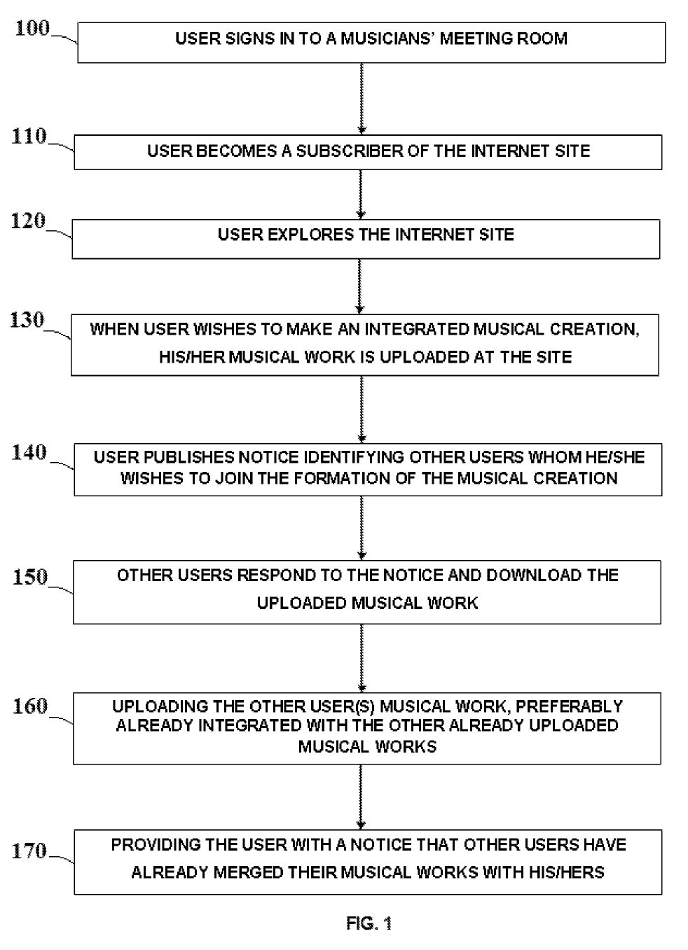

### DETAILED DESCRIPTION OF THE INVENTION

Different aspects of the present invention will now be illustrated using the following non-limiting example.

Let us assume that Richard who is a guitarist, wants to play soft rock'n'roll music and is looking for people to play with. He signs in to a musicians' meeting room (100) and begins the registering procedure in order to become a registered member of that site (step 110).

The registration procedure involves paying the prescribed registration fees and filling in a questionnaire about his musical preferences, the instrument he plays and personal details (e.g. e-mail address, home address, etc.). This data retrieved from the questionnaire may later be used when other users would like to approach Richard in order to establish ad hoc compositions of musicians. After signing in to the musicians' meeting room, Richard wonders at the site (step 120) in order to find people of similar interests to his own, by using a variety of data retrieval and communication options available in the site. He then may chat with some people sharing his own musical preferences, listen to music, observing advertisements that are presented at the site, etc.

When Richard decides to create a musical piece he plays this tune on his guitar and uploads it (step 130) in the musicians' meeting room. The musical work is tagged as a soft rock'n'roll guitar piece. Let us now assume that Richard wants to incorporate bass play and a drum play with his musical work. He then publishes a notice to registered members and classified as bass players and drum players and who have similar musical preferences (step 140). According to one embodiment of the invention, Richard is charged a certain fee for publishing the notice. Now Bob is such a bass player who is a registered member of this musicians' meeting room which has been found by the site's management software to have similar musical preferences as Richard. Bob will then receive a notice informing him of a guitar musical piece that needs a bass. He listens to the guitar musical work uploaded by Richard (step 150) either at the site by using his PC, or by downloading the music piece and listening to it on his own sound system. Once Bob decides to join in creating the integrated work, he uploads his bass piece (step 160) and by using the sound editing software available at the site, the two pieces are merged to form a one integrated piece. By another embodiment of the invention, Bob may be charged a certain fee (irrespective whether Richard has been charged for publishing the notice or not), and site manager will allow Bob's work to be combined with that of Richard. Upon creating the integrated work, Richard receives a notice (step 170) that Bob, a bass player, has answered his request and integrated his bass piece with the guitar piece. He may then listen to the merged piece, and contact Bob e.g. if he wishes to create more music with him.

Next, John who is a drum player receives a notice similar to the one which Bob had received. John enters the site and downloads the integrated musical work of Richard and Bob. He then records his musical work and has it integrated with the combined work of the two preceding players. Such a process may be repeated by using a number of instruments, preferably those that had initially been defined by the first user (Richard).

It is to be understood that the above description only includes some embodiments of the invention and serves for its illustration. Numerous other ways of carrying out the method provided by the present invention may be devised by a person skilled in the art without departing from the scope of the invention, and are thus encompassed by the present invention.

1. A method for enabling establishment of a musical creation by integrating a plurality of musical works performed non-simultaneously by a plurality of users, wherein said method comprises the steps of:
a) uploading the plurality of musical works at a pre-define Internet site;
b) integrating said plurality of musical works thereby establishing said musical creation.

2. A method according to claim 1, wherein users who are authorized to upload a musical work to said pre-defined Internet site, are paying subscribers of said Internet site.

3. A method according to claim 2, wherein subscription fees are charged from a computer user who wishes to initiate an integrated musical creation, or are charged on a fixed basis or any combination thereof.

4. A method according to claim 1, wherein users enter said pre-defined Internet site are exposed to advertisements inserted by operators of said Internet site.

5. A method according to claim 1, wherein the step of uploading said plurality of musical works comprises the steps of:
(a1) uploading at said pre-define Internet site a first musical work by a first user;
(a2) enabling at least one other user to listen to at least part of said first musical work; and
(a3) uploading at said pre-define site, at least one other musical work performed by said at least one other user.

6. A method according to claim 1, wherein the step of uploading the at least one other musical work is done irrespective of whether additional related musical works have already been uploaded.

7. A method according to claim 1, wherein uploading of said other musical works is carried out serially, each after a preceding musical work has been integrated with the latter's own preceding musical works.

8. A method according to claim 5, wherein step (a2) comprises enabling a second user to listen to said at least part of said first musical work while said second user uploads his/her musical work.

9. A method according to claim 5, wherein the uploaded at least one other musical work of step (a3) comprises an integrated work resulting from the integration of said first musical work with another musical work, and wherein the integrated resulting work is uploaded at the pre-defined site as the at least one other musical work.

10. A method according to claim 9, wherein by uploading a musical work according to steps (a1) and/or (a3) the respective user automatically waves his/her respective rights to the uploaded musical work.

11. A method according to claim 5, wherein said first user is provided with a capability to decide which other users would be allowed to have their musical works integrated with said first musical work or which other instruments will be used to create said at least one other musical work for integration with said first musical work.

12. A method according to claim 1, wherein the step of integrating said plurality of musical works comprises using sound editing software for merging and/or synchronizing said plurality of musical works into one musical creation.

13. A method according to claim 1, where said Internet site enables the use of an editing software operative to integrate said plurality of musical works into said one musical creation.

14. A method according to claim 1, further comprising a step of providing users with a questionnaire to enable determining their individual musical preferences.

15. A method according to claim 1, further comprising the step of providing means to allow users to rank various musical works that have been uploaded at said Internet site.
